(19) United States
(12) Patent Application Publication
(10) Pub. No.: US 2026/0213437 A1
(43) Pub. Date: Jul. 23, 2026

(54) SOCKET CONNECTION ASSEMBLY

(71) Applicant: Delta Electronics, Inc., Taoyuan City (TW)

(72) Inventors: Shao-Yu Wang, Taoyuan City (TW); Chien-Feng Chuang, Taoyuan City (TW); Hung-Yu Tseng, Taoyuan City (TW)

(21) Appl. No.: 19/085,442

(22) Filed: Mar. 20, 2025

(30) Foreign Application Priority Data
Jan. 23, 2025 (CN) 202510110225.0

(51) Int. Cl. H01R 12/51; H01R 4/02; H01R 12/72

(52) U.S. Cl. CPC H01R 12/51; H01R 4/029; H01R 12/722

(57) ABSTRACT

A socket connection assembly is disclosed and includes a socket, a connection board and metal connection components. The socket includes a main body and leading pins, and the leading pins are extended along a first direction. The connection board is disposed adjacent to the main body and parallel to the first direction. The metal connection components are connected between the leading pins and the connection board. The metal connection component includes a connection portion connected between a fitting end and a plug-in end. The fitting end is attached to the rear end of the main body, the connection portion is connected between the fitting end and the plug-in end, and the plug-in end runs through the connection board and forms an electrical connection through welding. The leading pins run through the fitting ends of the metal connection components and form an electrical connection through welding.

### CROSS-REFERENCE TO RELATED APPLICATION

This application claims priority to China Patent Application No. 202510110225.0, filed on Jan. 23, 2025. The entireties of the above-mentioned patent application are incorporated herein by reference for all purposes.

### FIELD OF THE INVENTION

The present disclosure relates to a power supply device, and more particularly to a socket connection assembly used in a power supply device utilizing metal connection components connected from leading pins of a socket to a connection board. It allows changing the direction in which the leading pins of the socket are connected to the circuit board, and also provides the freedom in the direction of the side panel, so as to avoid other mechanical components between the socket and the circuit board to optimize the space utilization and realize the automated production. At the same time, the stress absorption and the prevention of electrical interference are taken into account when plugging and unplugging the power cord.

### BACKGROUND OF THE INVENTION

In current daily life, power conversion modules are required to provide the power for many electronic device applications. The power conversion module mainly includes a combination of a socket and a circuit board. The socket is used to connect to the conductive plug of the power supply device, and the circuit board is connected to the socket. In that, the power conversion modules are configured to convert electrical energy and provide the required power to the electronic devices. Moreover, in the conventional power conversion modules, the socket and the circuit board are connected through the leading wires (jump wires).

Since the leading wires have to be welded manually after the socket and the circuit board are assembled, the conventional power conversion assembly structure is not conducive to the realization of the automated production. On the other hand, it is not easy to control the length change and direction of the wire connection. Furthermore, it is easy to cause the electrical electromagnetic interference (EMI) or the radio frequency interference (RIF) due to the crossing of the leading wires.

Therefore, there is a need of providing a socket connection assembly used in a power supply device utilizing metal connection components connected from leading pins of a socket to a connection board. It allows changing the direction in which the leading pins of the socket are connected to the circuit board, and also provides the freedom in the direction of the side panel, so as to avoid other mechanical components between the socket and the circuit board to optimize the space utilization and realize the automated production. At the same time, the stress absorption and the prevention of electrical interference are taken into account when plugging and unplugging the power cord, to obviate the drawbacks encountered from the prior arts.

### SUMMARY OF THE INVENTION

It is an object of the present disclosure to provide a socket connection assembly used in a power supply device utilizing metal connection components connected from leading pins of a socket to a connection board. It allows changing the direction in which the leading pins of the socket are connected to the circuit board, and also provides the freedom in the direction of the side panel, so as to avoid other mechanical components between the socket and the circuit board to optimize the space utilization and realize the automated production. At the same time, the stress absorption and the prevention of electrical interference are taken into account when plugging and unplugging the power cord.

It is another object of the present disclosure to provide a socket connection assembly used in a power supply device. The socket connection assembly is constructed between a main board of the power supply device and an external power cord. The one-piece metal connection component is connected between the leading pins protruding from the rear end of the socket and a connection board disposed on the side panel, so as to achieve a stable electrical connection, and provide the freedom in the direction of the side panel. It allows to avoid other mechanical component according to the practical requirements without taking up the extra space. Each metal connection component includes a fitting end and a plug-in end, the fitting end is attached to the rear end of the main body of the socket, and the plug-in end is inserted into the connection board. Moreover, the fitting end and the plug-in end are perpendicular to the leading pins of the socket, respectively. The fitting end and the plug-in end are connected through a connection portion. The connection portion is allowed having various bending structures to absorb the stress caused by plugging and unplugging the power cord into the socket, avoiding the tin cracks and avoiding other mechanical components. On the other hand, in order to comply with the electrical characteristics of electromagnetic compatibility (EMC), the socket further includes a metal sleeve made of Tin plate that is set on an outer periphery of the rear end of the main body. The metal sleeve can be designed to include a grounding portion, which has a wiring hole and covering the grounding pin of the socket. It allows the grounding pin of the socket to be connected to the metal sleeve without jump wires to achieve the grounding effect and avoid taking up the extra space. In this way, the socket connection assembly of the present disclosure occupies a small space in the power supply device, which can be easily introduced into later models with higher density. Moreover, the wiring holes of the pins on the socket are retained, and it allows the Y capacitor to be hooked and soldered therebetween, to meet the electrical requirements. In addition, the metal sleeve can also be designed with another grounding portion connected to a fixing component of the chassis to simultaneously implement grounding applications. In the present disclosure, the connection between the metal connection components and the leading pins of the socket is assisted by furnace welding through auxiliary tools designed according to the allowable tolerance, thereby realizing the automated production. The leading pins and the metal connection components can be correspondingly connected and fixed through a reflow soldering process. In addition, a spacer is disposed between the main body of the socket and the fitting ends of the two metal connection components to prevent the main body of the socket from being damaged by high temperatures during welding of the metal connection components and the leading pins of the socket. In the present disclosure, the metal connection components such as the copper sheets are utilized to construct the electrical connection between the socket and the connection board, such as the electrical connection of the live wire and the electrical connection of the neutral wire. The metal connection components connected to the vertical leading pins on the rear end of the socket are spaced apart to ensure that the minimum distance maintained between the two leading pins meets the safety requirements for electrical clearance and creepage distance. In addition, the grounding pin of the socket is integrated into the metal sleeve from the other side away from the connection board. It further ensures that the electrical connections of the live wire, the neutral wire and the grounding wire comply with the safety requirements of electrical clearance and creepage distance, and the electrical EMI/RFI interference caused by wire crossing is avoided. Furthermore, the plug-in ends of the two metal connection components on the connection board are misaligned to the latch component on the side panel to avoid interference. On the other hand, since the electrical connections between the socket and the connection board are realized through the metal connection components with structural strength, and integrated with the assembling procedure of the socket and the connection board, it is more helpful to realize the assembly structure of the socket, the connection board and the metal connection components by an automated production method. The assembling procedure is simplified, the production cost is reduced, and the competitiveness of the product is enhanced. The present disclosure includes the industrial applicability and the inventive steps.

In accordance with an aspect of the present disclosure, a socket connection assembly is provided and includes a socket, a connection board and two metal connection components. The socket includes a main body and two leading pins, and the two leading pins are extended from a rear end of the main body along a first direction, respectively. The connection board is disposed adjacent to a lateral side of the main body and parallel to the first direction. The two metal connection components are connected between the leading pins of the socket and the connection board, respectively. Each of the two metal connection components includes a fitting end, a connection portion and a plug-in end, the fitting end and the plug-in end are opposite to each other along a second direction and parallel to the second direction, and the second direction is perpendicular to the first direction, wherein the fitting end is attached to the rear end of the main body, the connection portion is connected between the fitting end and the plug-in end, and the plug-in end runs through the connection board and forms an electrical connection through welding, wherein the two leading pins run through the fitting ends of the two metal connection components and form an electrical connection through welding, respectively.

In an embodiment, the socket connection assembly further includes a spacer disposed between the rear end of the main body and the fitting ends of the two metal connection components.

In an embodiment, the connection portion includes a semicircular bent section connected between the fitting end and the plug-in end.

In an embodiment, the connection portion further includes a first connection section, a second connection section and a third connection section, the fitting end is connected to the plug-in end through the first connection section, the second connection section and the third connection section in sequence, the first connection section and the third connection section are parallel to the second direction, respectively, and the second connection section is parallel to the first direction.

In an embodiment, the connection portion further includes a first connection section, a second connection section, a third connection section and a fourth connection section, and the fitting end is connected to the plug-in end through the first connection section, the second connection section, the third connection section and the fourth connection section in sequence, wherein the first connection section and the third connection section are parallel to the first direction, respectively, and the second connection section and the fourth connection section are parallel to the second direction, respectively.

In an embodiment, the connection portion includes a first connection section parallel to the second direction, and connected between the fitting end and the plug-in end.

In an embodiment, the socket further includes a metal sleeve, wherein the metal sleeve is sleeved on an outer periphery of the main body and disposed adjacent to the rear end of the main body, and the socket further includes a grounding pin extended from the rear end of the main body along the first direction, wherein the metal sleeve further includes a first grounding portion extended from the outer periphery of the main body along a surface of the main body and electrically connected to one end of the grounding pin.

In an embodiment, the first grounding portion covers the grounding pin, and each of the first grounding portion and the grounding pin has a wiring hole, wherein when the first grounding portion covers the grounding pin, the wiring hole of the first grounding portion and the wiring hole of the grounding pin are in communication with each other.

In an embodiment, the grounding pin and the connection board are located on two opposite sides of the two metal connection components, respectively.

In an embodiment, each of the two leading pins and the grounding pin is a flat pin parallel to the first direction.

In an embodiment, the socket connection assembly further includes an electronic device connected between one of the two leading pins and the grounding pin.

In an embodiment, the socket connection assembly is applied to a power supply device and fixed to a chassis, wherein the chassis includes a side panel and a fixing component, the socket connection assembly is fixed to the side panel through the fixing component, and the connection board is disposed adjacent to the side plate and inserted into a main board of the power supply device.

In an embodiment, the fixing component includes a grounding platform extended from outside to inward, wherein the metal sleeve includes a second grounding portion spatially corresponding to the grounding platform, and the second grounding portion and the grounding platform are connected to each other.

In an embodiment, the chassis further includes a latch disposed on the side plate along the first direction, and parallel to the connection board, wherein the latch is located between the plug-in ends of the two metal connection components and misaligned to the plug-in ends of the two metal connection components in view of the second direction.

In an embodiment, the socket includes an engaging protrusion disposed on an outer periphery of the main body, and the fixing component includes an engaging opening spatially corresponding to the engaging protrusion, wherein the socket is mounted on the fixing component by engaging the engaging protrusion and the engaging opening with each other, and the connection board is disposed adjacent to the side plate.

In an embodiment, the two leading pins are arranged along a third direction, and are a flat pin, respectively, wherein the third direction is perpendicular to the first direction and the second direction.

In an embodiment, the two leading pins are both flat pins and each has a wiring hole, wherein after the two leading pins penetrate the fitting ends of the two metal connection components respectively, the wiring holes of the two leading pins remain exposed.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic structural view illustrating a socket connection assembly used for connecting a power supply device and an external power cord according to a first embodiment of the present disclosure;

FIG. 2 is a top view illustrating the internal structure of the socket connection assembly used in the power supply device according to the first embodiment of the present disclosure;

FIG. 3 is a rear view illustrating the internal structure of the socket connection assembly used in the power supply device according to the first embodiment of the present disclosure;

FIG. 4 is schematic structural view illustrating the socket connection assembly combined with the fixing component according to the first embodiment of the present disclosure;

FIG. 5 is a structural exploded view illustrating the socket connection assembly combined with the fixing component according to the first embodiment of the present disclosure;

FIG. 6 is a lateral view illustrating the socket connection assembly according to the first embodiment of the present disclosure;

FIG. 7 is a schematic structural view illustrating a socket connection assembly according to a second embodiment of the present disclosure;

FIG. 8 is a structural exploded view illustrating the socket connection assembly according to the second embodiment of the present disclosure;

FIG. 9 is a lateral view illustrating the socket connection assembly according to the second embodiment of the present disclosure;

FIG. 10 is a schematic structural view illustrating a socket connection assembly according to a third embodiment of the present disclosure;

FIG. 11 is a structural exploded view illustrating the socket connection assembly according to the third embodiment of the present disclosure;

FIG. 12 is a lateral view illustrating the socket connection assembly according to the third embodiment of the present disclosure;

FIG. 13 is a schematic structural view illustrating a socket connection assembly according to a fourth embodiment of the present disclosure;

FIG. 14 is a structural exploded view illustrating the socket connection assembly according to the fourth embodiment of the present disclosure; and

FIG. 15 is a lateral view illustrating the socket connection assembly according to the fourth embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “front,” “rear,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items.

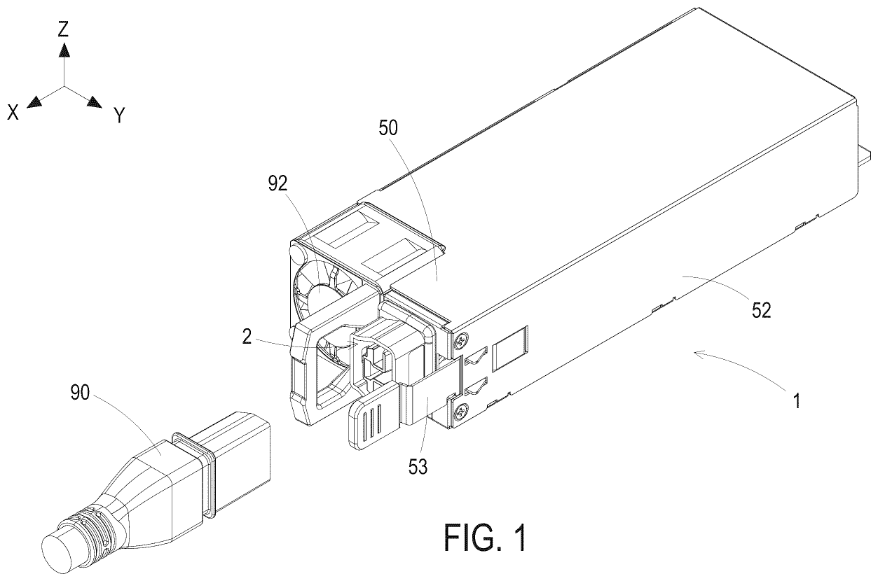

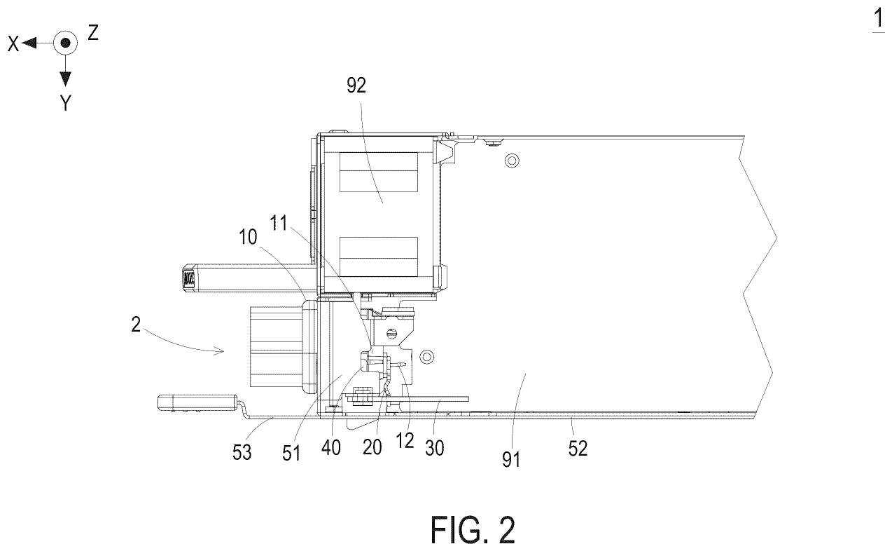

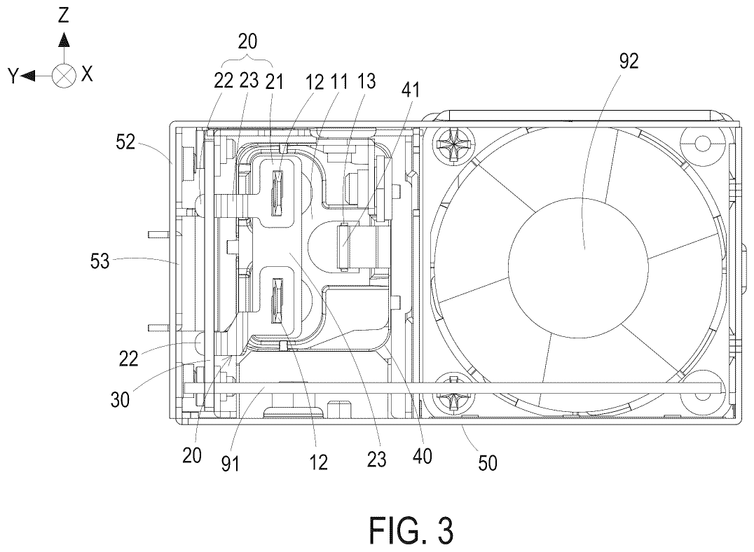

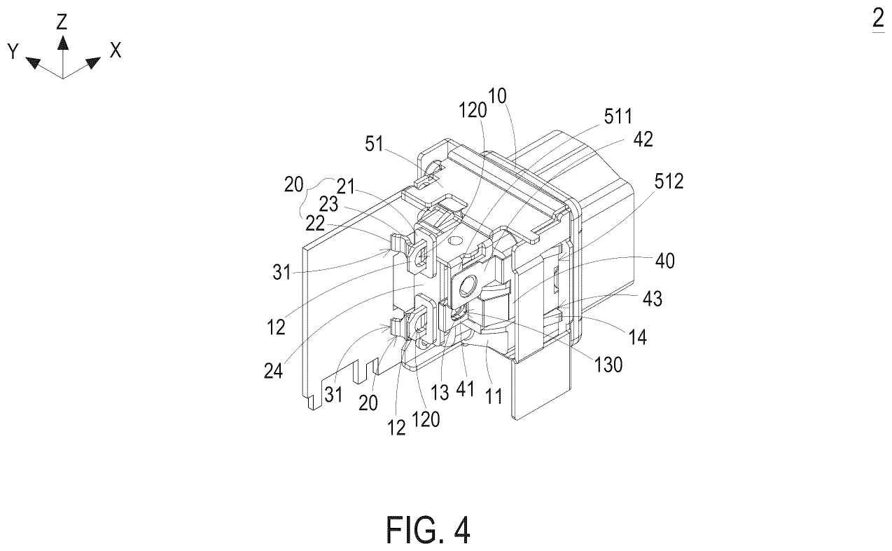

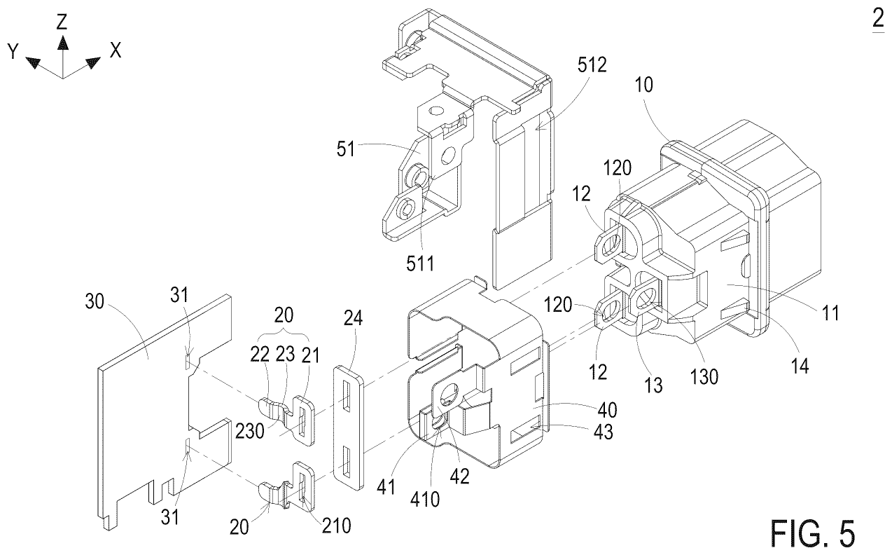

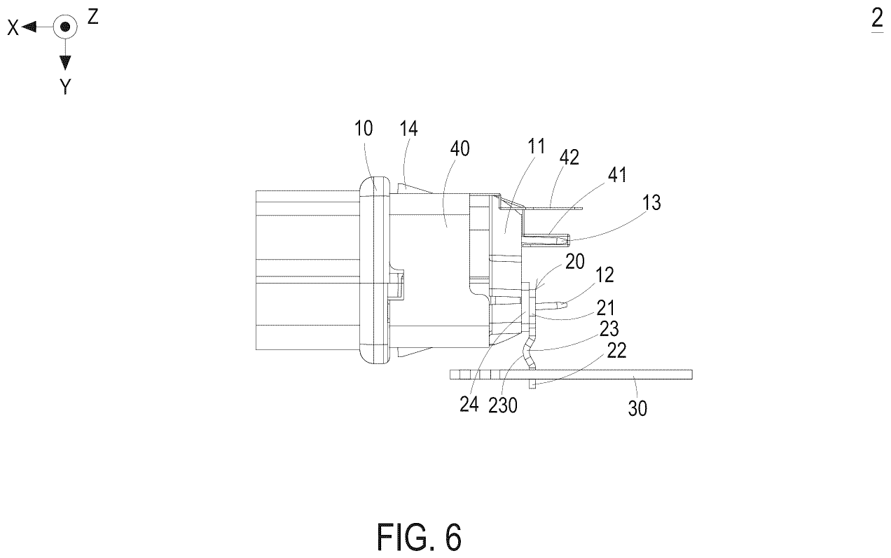

FIG. 1 is a schematic structural view illustrating a socket connection assembly used for connecting a power supply device and an external power cord according to a first embodiment of the present disclosure. FIG. 2 is a top view illustrating the internal structure of the socket connection assembly used in the power supply device according to the first embodiment of the present disclosure. FIG. 3 is a rear view illustrating the internal structure of the socket connection assembly used in the power supply device according to the first embodiment of the present disclosure. FIG. 4 is schematic structural view illustrating the socket connection assembly combined with the fixing component according to the first embodiment of the present disclosure. FIG. 5 is a structural exploded view illustrating the socket connection assembly combined with the fixing component according to the first embodiment of the present disclosure. FIG. 6 is a lateral view illustrating the socket connection assembly according to the first embodiment of the present disclosure. In the embodiment, a socket connection assembly 2 is provided and applied to a power supply device 1. The socket connection assembly 2 is arranged between the main board 91 of the power supply device 1 and an external power cord 90, and configured to provide the power source converted by the main board 91 to the external power cord 90. Preferably but not exclusively, the socket connection assembly 2 is constructed together with a fan module 92 at the front end of a chassis 50. In the embodiment, the socket connection assembly 2 is illustrated as being disposed adjacent to a side panel 52 of the chassis 50. The configurations of the main board 91 and the fan module 92 is not an essential technical feature of the present disclosure and is explained first. Furthermore, the chassis 50 includes the side panel 52 and a fixing component 51, and the socket connection assembly 2 is fixed between the top panel, the bottom panel and the side panel 52 of the chassis 50 through the fixing component 51. Preferably but exclusively, the fixing component 51 is regarded as a part of the chassis 50. In the embodiment, the socket connection assembly 2 includes a socket 10, a connection board 30 and two metal connection components 20. The socket 10 includes a main body 11 and two leading pins 12, and the two leading pins 12 are extended from a rear end of the main body 11 along a first direction (i.e., the inverse X-axis direction), respectively. The connection board 30 is disposed adjacent to a lateral side of the main body 11 and parallel to the first direction (i.e., the inverse X-axis direction). Preferably but not exclusively, the connection board 30 is spatially corresponding to the side panel 52 of the chassis 50, close to the inner wall of the side panel 52, and inserted on the main board 91 of the power supply device 1. In the embodiment, the two metal connection components 20 are connected between the leading pins 12 of the socket 10 and the connection board 30, respectively. In the embodiment, each of the two metal connection components 20 includes a fitting end 21, a connection portion 23 and a plug-in end 22. The fitting end 21 and the plug-in end 22 are opposite to each other along a second direction (i.e., the Y-axis direction) and parallel to the second direction, and the second direction is perpendicular to the first direction. Preferably but not exclusively, in the embodiment, two leading pins 12 are arranged along a third direction (i.e., the Z-axis direction), and are a line wire (live wire) leading pin and a neutral wire leading pin respectively, with a similar structure. Preferably but not exclusively, the two metal connection components 20 are made of a copper sheet, respectively. Each metal connection component 20 is integrally formed into one piece. In the embodiment, the fitting end 21 of the metal connection component 20 is attached to the rear end of the main body 11, the connection portion 23 is connected between the fitting end 21 and the plug-in end 22, and the plug-in end 22 runs through the connection board 30 and forms an electrical connection through welding. In addition, the two leading pins 12 run through two engagement apertures 210 on the fitting ends 21 of the two metal connection components 20 and form an electrical connection through welding, respectively. In the socket connection assembly 2 of the present disclosure, the leading pins 12 on the rear end of the socket 10 parallel to the first direction (i.e., the inverse X-axis direction) are vertically connected to the connection board 30 along the second direction (i.e., the Y-axis direction) by means of the integrally formed metal connection components 20. A stable electrical connection with the shortest path is achieved, and the freedom of the direction of the side panel 52 can be provided, so as to avoid other mechanical components on the connection board 30 or on the main board 91 according to the practical requirements without occupying an extra space. In addition, the metal connection components 20 such as the copper sheets are utilized to construct the electrical connection between the socket 10 and the connection board 30, such as the electrical connection of the live wire and the electrical connection of the neutral wire. The two metal connection components 20 connected to the vertical leading pins 12 on the rear end of the socket 10 are spaced apart to ensure that the minimum distance maintained therebetween meets the safety requirements for electrical clearance and creepage distance.

In the embodiment, each connection portion 23 of the two metal connection component 20 includes a semicircular bent section 230, and the semicircular bent section 230 is connected between the fitting end 21 and the plug-in end 22. Notably, in the embodiment, each fitting end 21 of the two metal connection components 20 is fitted to the rear end of the main body 11 of the socket 10, parallel to the second direction (i.e., the Y-axis direction), and connected to the corresponding leading pin 12. Each plug-in end 22 of the two metal connection components 20 is inserted into a mounting aperture 31 on the connection board 30, and parallel to the second direction (i.e., the Y-axis direction). In other words, the fitting end 21 and the plug-in end 22 are both disposed perpendicular to the extending direction (i.e., the inverse X-axis direction) of the leading pins 12 of the socket 10. Since the fitting end 21 and the plug-in end 22 are connected by the connection portion 23 having the semicircular bent section 230, when the external power cord 90 is inserted into the socket 10 along the first direction (i.e., the inverse X-axis direction) or pulled out of the socket 10 along the X-axis direction, the stress change caused by plugging and unplugging the external power cord 90 into the socket connection assembly 2 can be absorbed by the design of the semicircular bent section 230, avoiding the tin cracks between the metal connection components 20 and the leading pins 12 or between the metal connection components 20 and the connection board 30. Certainly, the number, the size and the direction of the semicircular bent section 230 are adjustable according to the practical requirements.

In order to comply with the electrical characteristics of electromagnetic compatibility (EMC), the socket 10 further includes a metal sleeve 40. Preferably but not exclusively, the metal sleeve 40 is made of Tinplate that is sleeved on an outer periphery of the rear end of the main body 11, and disposed adjacent to the rear end of the main body 11. In the embodiment, the socket 10 further includes a grounding pin 13 extended from the rear end of the main body 11 along the first direction (i.e., the inverse X-axis direction). Preferably but not exclusively, the grounding pin 13 is located at one side of the two leading pins 12 away from the connection board 30. In the embodiment, the metal sleeve 40 further includes a first grounding portion 41 extended from the outer periphery of the main body 11 along a surface of the main body 11 and electrically connected to one end of the grounding pin 13. In that, the grounding pin 13 of the socket 10 can be connected to the metal sleeve 40 without jump wires to achieve the grounding effect and avoid taking up the extra space. In addition, the grounding pin 13 of the socket 10 is integrated into the first grounding portion 41 of the metal sleeve 40 from the other side away from the connection board 30. It further ensures that the electrical connections of the live wire, the neutral wire and the grounding wire comply with the safety requirements of electrical clearance and creepage distance, and the electrical EMI/RFI interference caused by wire crossing is avoided.

In the embodiment, the two leading pins 12 of the socket 10 are both flat pins and parallel to the first direction (i.e., the inverse X-axis direction). Moreover, each of the two leading pins 12 has a wiring hole 120. In the embodiment, after the two leading pins 12 penetrate the fitting ends 21 of the two metal connection components 20, respectively, the wiring holes 120 of the two leading pins 12 remain exposed, and allow for connection to other devices. Furthermore, in the embodiment, the grounding pin 13 includes a wiring hole 130. The first grounding portion 41 is further extended along an outer edge of the grounding pin 13 to cover the grounding pin 13. Moreover, the first grounding portion 41 has a wiring hole 410. When the first grounding portion 41 covers the grounding pin 13, the wiring hole 410 of the first grounding portion 41 and the wiring hole 130 of the grounding pin 13 are in communication with each other, and allow for connection to other devices. In an embodiment, the wiring hole 120 of the leading pin 12 and the wiring hole 130 of the grounding pin 13 are retained, and it allows the Y capacitor (not shown) to be hooked and soldered therebetween, to meet the electrical requirements. Preferably but not exclusively, in other embodiments, the socket connection assembly 2 further includes other electronic devices (capacitors) besides capacitors, connected between one of the two leading pins 12 and the grounding pin 13, but the present disclosure is not limited thereto.

In the embodiment, the socket connection assembly 2 is applied to the power supply device 1 and fixed to the side panel 52 through the fixing component 51. The fixing component 51 can be regarded as a part of the chassis 50. The connection board 30 is close to the side panel 52 and inserted on the main board 91 of the power supply device 1. In the embodiment, the socket 10 includes an engaging protrusion 14 disposed on an outer periphery of the main body 11, and the fixing component 51 includes an engaging opening 512 spatially corresponding to the engaging protrusion 14. In the embodiment, the socket 10 is mounted on the fixing component 51 by engaging the engaging protrusion 14 and the engaging opening 512 with each other. Certainly, the socket 10 and the fixing component 51 can be fixed together by other means such as buckles or bolts. The method of fixing the socket 10 to the chassis 50 through the fixing component 51 is adjustable, and the present disclosure is not limited thereto. In the embodiment, after the socket 10 is fixed to the chassis 50 through the fixing component 51, and the connection board 30 is disposed adjacent to the side plate 52. Preferably but not exclusively, the connection board 30 and the side plate 52 are parallel to each other along the first direction (i.e., the inverse X-axis direction). In the embodiment, the fixing component 51 is made of, for example, a conductive metal material, and further includes a grounding platform 511 extended from outside to inward. Moreover, the metal sleeve 40 includes a second grounding portion 42 spatially corresponding to the grounding platform 511. Preferably but not exclusively, in the embodiment, the second grounding portion 511 and the grounding platform 42 are fixed to each other through a screw so as to achieve the mutual ground connection. Furthermore, in the embodiment, the chassis 50 further includes a latch 53 disposed on the side plate 52 along the first direction (i.e., the inverse X-axis direction), and parallel to the connection board 30. Moreover, the latch 53 is located between the plug-in ends 22 of the two metal connection components 20 and misaligned to the plug-in ends 22 of the two metal connection components 20 in view of the second direction (i.e., the Y-axis direction), so as to avoid the interference.

In the embodiment, since the electrical connections between the socket 10 and the connection board 30 are realized through the metal connection components 20 with structural strength, and integrated with the assembling procedure of the socket 10 and the connection board 30, it is more helpful to realize the assembly structure of the socket 10, the connection board 30 and the metal connection components 20 by an automated production method. The assembling procedure is simplified, the production cost is reduced, and the competitiveness of the product is enhanced. In the embodiment, the connection between the metal connection components 20 and the leading pins 12 of the socket 10 can be assisted by furnace welding through auxiliary tools designed according to the allowable tolerance, thereby realizing the automated production. The socket 10 and the two metal connection components 20 can be put into a furnace together with the auxiliary tools for a reflow soldering process, so that the leading pins 12 and the metal connection components 20 are correspondingly connected and fixed through the reflow soldering process. In addition, the socket connection assembly 2 further includes a spacer 24 disposed between the rear end of the main body 11 and the fitting ends 21 of the two metal connection components 20. Preferably but not exclusively, the spacer 24 is made of an insulation heat-resistant material. By setting the insulation heat-resistant spacer 24 between the main body 11 of the socket 10 and the fitting ends 21 of the two metal connection components 20, it further prevents the main body 11 of the socket 10 from being damaged by high temperatures during welding of the metal connection components 20 and the leading pins 12 of the socket 10. Certainly, the present disclosure is not limited thereto.

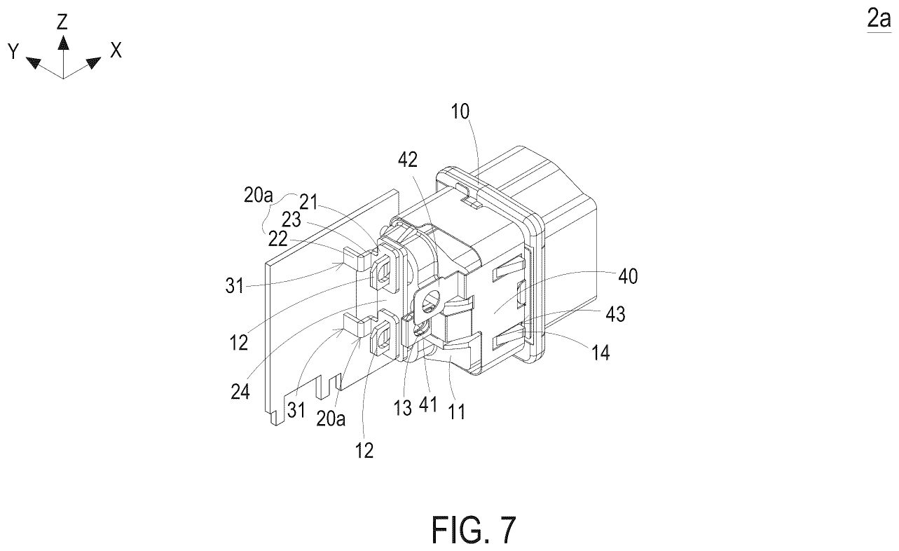

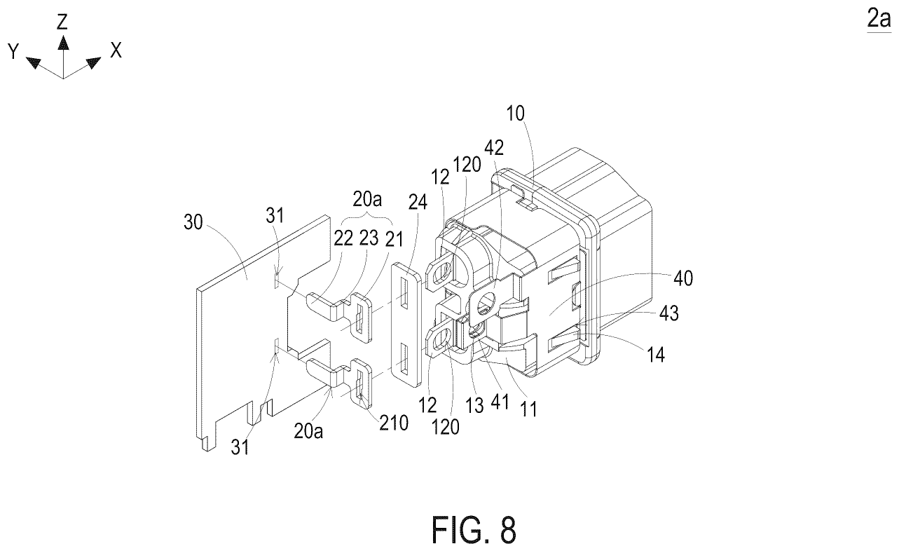

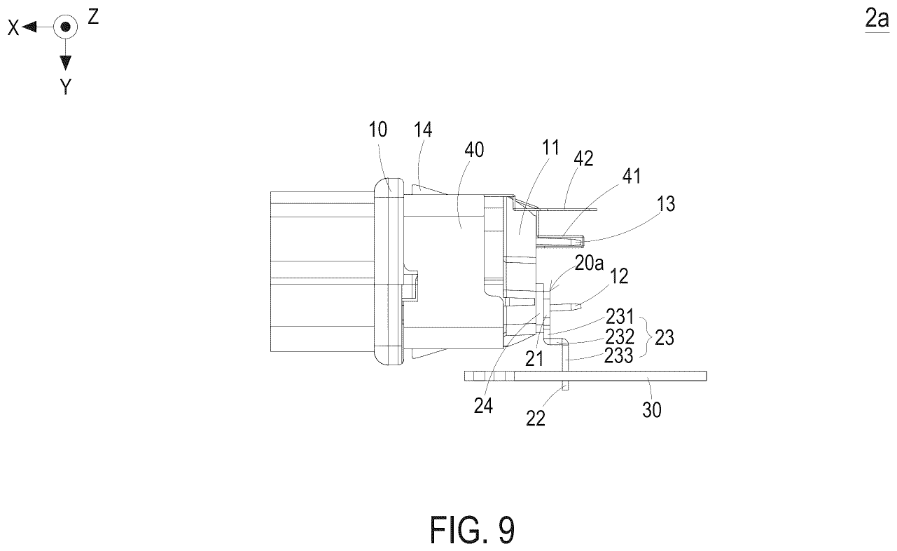

FIG. 7 is a schematic structural view illustrating a socket connection assembly according to a second embodiment of the present disclosure. FIG. 8 is a structural exploded view illustrating the socket connection assembly according to the second embodiment of the present disclosure. FIG. 9 is a lateral view illustrating the socket connection assembly according to the second embodiment of the present disclosure. In the embodiment, the structures, elements and functions of the socket connection assembly 2a are similar to those of the socket connection assembly 2 in FIG. 1 to FIG. 6, and are not redundantly described herein. In the embodiment, the two metal connection components 20a are formed by bending copper sheets, for example, and are easy to process and shape. Each connection portion 23 of the metal connection component 20a further includes a first connection section 231, a second connection section 232 and a third connection section 233. Each fitting end 21 of the metal connection component 20a is parallel to the second direction (i.e., the Y-axis direction) and connected to the plug-in end 22 through the first connection section 231, the second connection section 232 and the third connection section 233 in sequence. Preferably but not exclusively, the first connection section 231 and the third connection section 233 are parallel to the second direction (i.e., the Y-axis direction), respectively, and the second connection section 232 is parallel to the first direction (i.e., the inverse X-axis direction). With the design of the first connection section 231, the second connection section 232 and the third connection section 233, it facilitates each plug-in end 22 of the metal connection components 20a to cooperate with the corresponding mounting aperture 31 which is displaced along the first direction (i.e., the inverse X-axis direction) on the connection board 30 along the first direction (i.e., the direction opposite to the X-axis) to realize the electrical connection between the leading pins 12 of the socket 10 and the connection board 30. In that, the sufficient structural support between the fitting end 21 and the plug end 22 is provided by the connection portion 23. The bending structure is allowed having various bending structures to absorb the stress caused by plugging and unplugging the external power cord 90 (referring to FIG. 1) into the socket 10, and it avoids the tin tracks. At the same time, it also provides the freedom of adjustment to avoid other mechanical components.

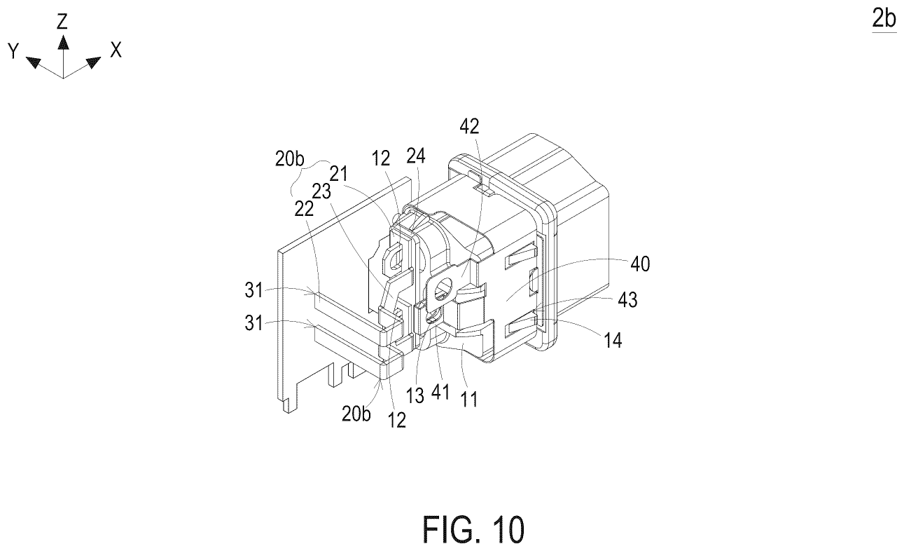

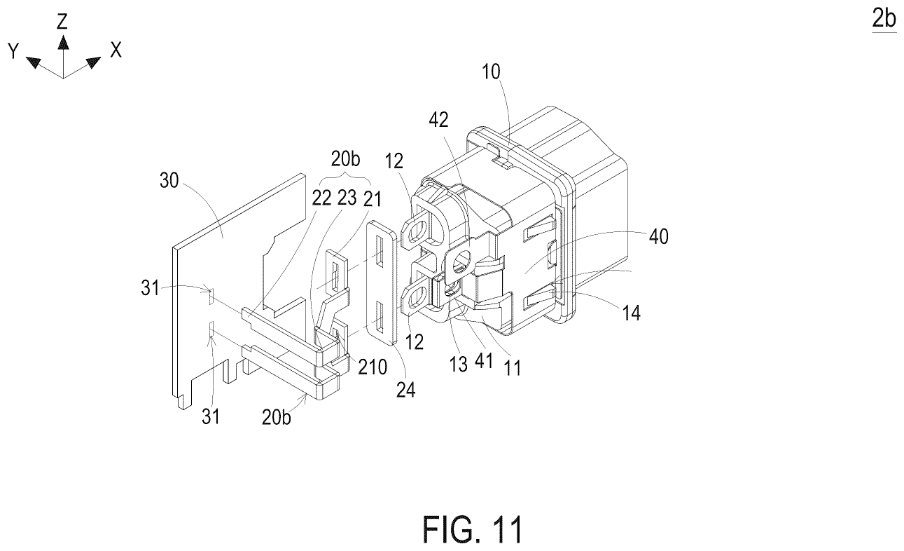

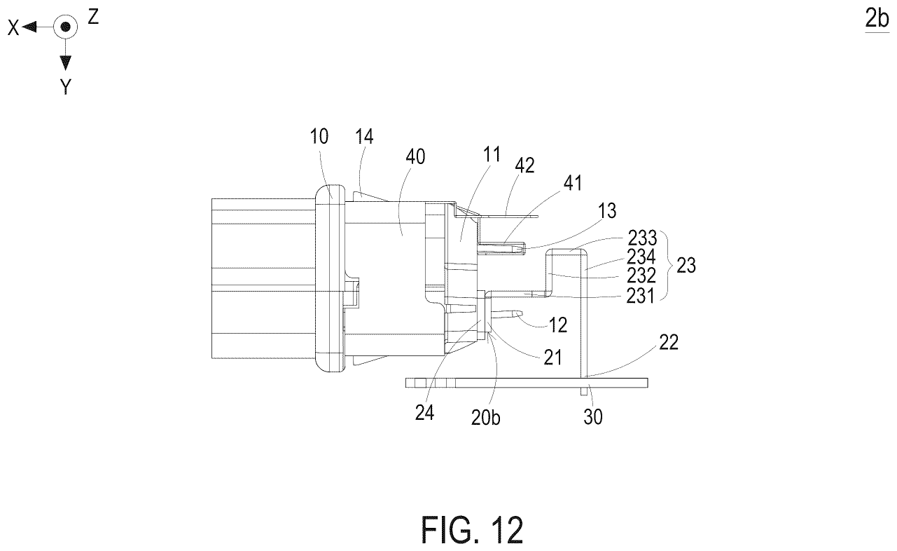

FIG. 10 is a schematic structural view illustrating a socket connection assembly according to a third embodiment of the present disclosure. FIG. 11 is a structural exploded view illustrating the socket connection assembly according to the third embodiment of the present disclosure. FIG. 12 is a lateral view illustrating the socket connection assembly according to the third embodiment of the present disclosure. In the embodiment, the structures, elements and functions of the socket connection assembly 2b are similar to those of the socket connection assembly 2 in FIG. 1 to FIG. 6, and are not redundantly described herein. Preferably but not exclusively, in the embodiment, the two metal connection components 20b are formed by bending copper sheets. Each connection portion 23 of the metal connection component 20a further includes a first connection section 231, a second connection section 232, a third connection section 233 and a fourth connection section 234. Each fitting end 21 of the metal connection component 20b is parallel to the second direction (i.e., the Y-axis direction), and connected to the plug-in end 22 through the first connection section 231, the second connection section 232, the third connection section 233 and the fourth connection section 234 in sequence. Preferably but not exclusively, the first connection section 231 and the third connection section 233 are parallel to the first direction (i.e., the inverse X-axis direction), respectively, and the second connection section 232 and the fourth connection section 234 are parallel to the second direction (i.e., the Y-axis direction), respectively. In the embodiment, the first connection section 231, the second connection section 232 and the third connecting section 233 are located on the other side of the two leading pins 12 away from the connection board 30, and it helps to avoid the other devices on the connection board 30. Furthermore, each first connection section 231 of the two metal connection components 20b is allowed to shift in the third direction (i.e., the Z-axis direction) to adjust the distance between the two metal connection components 20b and to match the positions of the two mounting apertures 31 which are adjusted in the second direction and the third direction on the connection board 30. In that, the plug-in ends 22 of the two metal connection components 20b can be accurately plugged into the connection board 30. In the present disclosure, each one-piece metal connection component 20b is connected between the leading pins 12 protruding from the rear end of the socket 10 and the connection board 30 disposed on the side panel 52, so as to achieve a stable electrical connection, and provide the freedom in the direction of the side panel 52. Each connection portion 23 of the metal connection components 20b is allowed avoiding the other mechanical components according to the practical requirements, and having various bending structures to absorb the stress caused by plugging and unplugging the external power cord 90 (referring to FIG. 1) into the socket 10. Moreover, it avoids tin cracks.

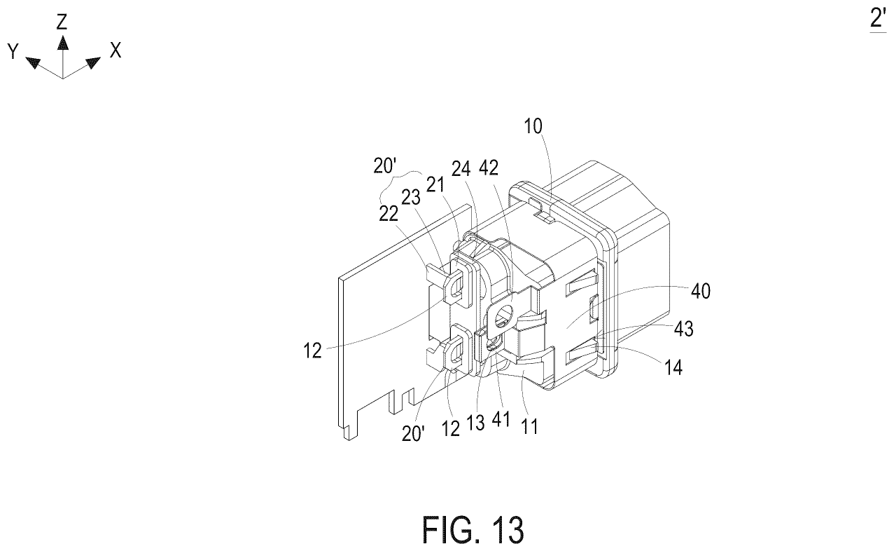

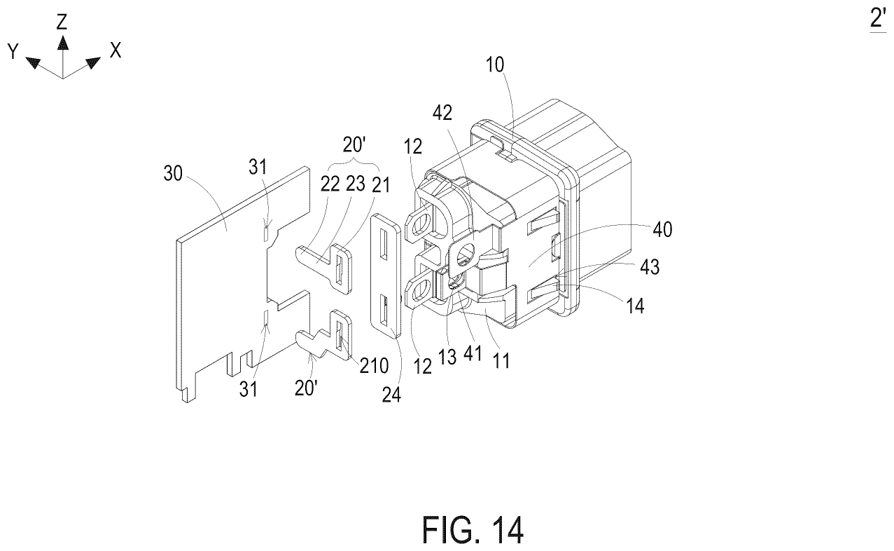

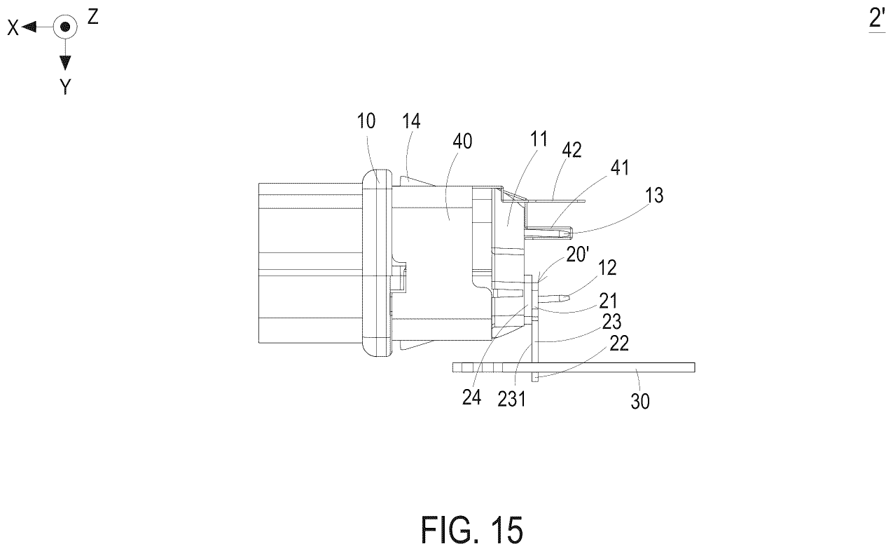

FIG. 13 is a schematic structural view illustrating a socket connection assembly according to a fourth embodiment of the present disclosure. FIG. 14 is a structural exploded view illustrating the socket connection assembly according to the fourth embodiment of the present disclosure. FIG. 15 is a lateral view illustrating the socket connection assembly according to the fourth embodiment of the present disclosure. In the embodiment, the structures, elements and functions of the socket connection assembly 2′ are similar to those of the socket connection assembly 2 in FIG. 1 to FIG. 6, and are not redundantly described herein. Preferably but not exclusively, in the embodiment, the two metal connection components 20′ are formed by bending copper sheets. Each connection portion 23 of the metal connection component 20′ further includes a first connection section 231, which is parallel to the second direction (i.e., the Y-axis direction) and connected between the fitting end 21 and the plug-in end 22. Each first connection section 231 of the two metal connection components 20′ is allowed to shift in the third direction (i.e., the Z-axis direction) to match the spaced distance of the two mounting apertures 31 on the connection board 30. In that, the plug-in ends 22 of the two metal connection components 20′ can be accurately plugged into the connection board 30. Moreover, the minimum distance for electrical connection is achieved while meeting the safety requirements for electrical clearance and creepage distance. In this way, the socket connection assembly 2′ of the present disclosure occupies a small space in the power supply device 1, which can be easily introduced into later models with higher density. Certainly, the present disclosure is not limited thereto.

From the above, the metal connection components 20, 20a, 20b, 20′in the socket connector assemblies 2, 2a, 2b, 2′ can adjust the structures of the connection portions 23 according to the practical requirements, so as to achieve the purposes of absorbing the stress and avoiding other mechanical components. Certainly, the metal connection components 20, 20a, 20b, 20′ in the same socket connection assembly 2, 2a, 2b, 2′ are not limited to having similar structures in accordance with the safety requirements for electrical clearance and creepage distance. It allows to adjust the combination of the two metal connection components 20, 20a, 20b, 20′ in the same one of the socket connection assemblies 2, 2a, 2b, 2′ according to the practical requirements without affecting the grounding design of the grounding pin 13 being integrated into the metal sleeve 40 and the fixing component 51. Certainly, after completing the socket connection assemblies 2, 2a, 2b, 2′, the wiring hole 120 of the leading pin 12 and the wiring hole 130 of the grounding pin 13 are retained, and it allows other electronic devices to be hooked therebetween to achieve various connection applications. Certainly, the present disclosure is not limited thereto and not redundantly described hereafter.

In summary, the present disclosure provides a socket connection assembly used in a power supply device utilizing metal connection components connected from leading pins of a socket to a connection board. It allows changing the direction in which the leading pins of the socket are connected to the circuit board, and also provides the freedom in the direction of the side panel, so as to avoid other mechanical components between the socket and the circuit board to optimize the space utilization and realize the automated production. At the same time, the stress absorption and the prevention of electrical interference are taken into account when plugging and unplugging the power cord. The socket connection assembly is constructed between a main board of the power supply device and an external power cord. The one-piece metal connection component is connected between the leading pins protruding from the rear end of the socket and a connection board disposed on the side panel, so as to achieve a stable electrical connection, and provide the freedom in the direction of the side panel. It allows to avoid other mechanical component according to the practical requirements without taking up the extra space. Each metal connection component includes a fitting end and a plug-in end, the fitting end is attached to the rear end of the main body of the socket, and the plug-in end is inserted into the connection board. Moreover, the fitting end and the plug-in end are perpendicular to the leading pins of the socket, respectively. The fitting end and the plug-in end are connected through a connection portion. The connection portion is allowed having various bending structures to absorb the stress caused by plugging and unplugging the power cord into the socket, avoiding the tin cracks and avoiding other mechanical components. On the other hand, in order to comply with the electrical characteristics of electromagnetic compatibility (EMC), the socket further includes a metal sleeve made of Tin plate that is set on an outer periphery of the rear end of the main body. The metal sleeve can be designed to include a grounding portion, which has a wiring hole and covering the grounding pin of the socket. It allows the grounding pin of the socket to be connected to the metal sleeve without jump wires to achieve the grounding effect and avoid taking up the extra space. In this way, the socket connection assembly of the present disclosure occupies a small space in the power supply device, which can be easily introduced into later models with higher density. Moreover, the wiring holes of the pins on the socket are retained, and it allows the Y capacitor to be hooked and soldered therebetween, to meet the electrical requirements. In addition, the metal sleeve can also be designed with another grounding portion connected to a fixing component of the chassis to simultaneously implement grounding applications. In the present disclosure, the connection between the metal connection components and the leading pins of the socket is assisted by furnace welding through auxiliary tools designed according to the allowable tolerance, thereby realizing the automated production. The leading pins and the metal connection components can be correspondingly connected and fixed through a reflow soldering process. In addition, a spacer is disposed between the main body of the socket and the fitting ends of the two metal connection components to prevent the main body of the socket from being damaged by high temperatures during welding of the metal connection components and the leading pins of the socket. In the present disclosure, the metal connection components such as the copper sheets are utilized to construct the electrical connection between the socket and the connection board, such as the electrical connection of the live wire and the electrical connection of the neutral wire. The metal connection components connected to the vertical leading pins on the rear end of the socket are spaced apart to ensure that the minimum distance maintained between the two leading pins meets the safety requirements for electrical clearance and creepage distance. In addition, the grounding pin of the socket is integrated into the metal sleeve from the other side away from the connection board. It further ensures that the electrical connections of the live wire, the neutral wire and the grounding wire comply with the safety requirements of electrical clearance and creepage distance, and the electrical EMI/RFI interference caused by wire crossing is avoided. Furthermore, the plug-in ends of the two metal connection components on the connection board are misaligned to the latch component on the side panel to avoid interference. On the other hand, since the electrical connections between the socket and the connection board are realized through the metal connection components with structural strength, and integrated with the assembling procedure of the socket and the connection board, it is more helpful to realize the assembly structure of the socket, the connection board and the metal connection components by an automated production method. The assembling procedure is simplified, the production cost is reduced, and the competitiveness of the product is enhanced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A socket connection assembly, comprising:
a socket, comprising a main body and two leading pins, wherein the two leading pins are extended from a rear end of the main body along a first direction, respectively;
a connection board, disposed adjacent to a lateral side of the main body and parallel to the first direction; and
two metal connection components, connected between the leading pins of the socket and the connection board, respectively, wherein each of the two metal connection components comprises a fitting end, a connection portion and a plug-in end, the fitting end and the plug-in end are opposite to each other along a second direction and parallel to the second direction, and the second direction is perpendicular to the first direction, wherein the fitting end is attached to the rear end of the main body, the connection portion is connected between the fitting end and the plug-in end, and the plug-in end runs through the connection board and forms an electrical connection through welding, wherein the two leading pins run through the fitting ends of the two metal connection components and form an electrical connection through welding, respectively.

2. The socket connection assembly according to claim 1, further comprising a spacer disposed between the rear end of the main body and the fitting ends of the two metal connection components.

3. The socket connection assembly according to claim 1, wherein the connection portion comprises a semicircular bent section connected between the fitting end and the plug-in end.

4. The socket connection assembly according to claim 1, wherein the connection portion further comprises a first connection section, a second connection section and a third connection section, the fitting end is connected to the plug-in end through the first connection section, the second connection section and the third connection section in sequence, the first connection section and the third connection section are parallel to the second direction, respectively, and the second connection section is parallel to the first direction.

5. The socket connection assembly according to claim 1, wherein the connection portion further comprises a first connection section, a second connection section, a third connection section and a fourth connection section, and the fitting end is connected to the plug-in end through the first connection section, the second connection section, the third connection section and the fourth connection section in sequence, wherein the first connection section and the third connection section are parallel to the first direction, respectively, and the second connection section and the fourth connection section are parallel to the second direction, respectively.

6. The socket connection assembly according to claim 1, wherein the connection portion comprises a first connection section parallel to the second direction, and connected between the fitting end and the plug-in end.

7. The socket connection assembly according to claim 1, wherein the socket further comprises a metal sleeve, wherein the metal sleeve is sleeved on an outer periphery of the main body and disposed adjacent to the rear end of the main body, and the socket further comprises a grounding pin extended from the rear end of the main body along the first direction, wherein the metal sleeve further comprises a first grounding portion extended from the outer periphery of the main body along a surface of the main body and electrically connected to one end of the grounding pin.

8. The socket connection assembly according to claim 7, wherein the first grounding portion covers the grounding pin, and each of the first grounding portion and the grounding pin has a wiring hole, wherein when the first grounding portion covers the grounding pin, the wiring hole of the first grounding portion and the wiring hole of the grounding pin are in communication with each other.

9. The socket connection assembly according to claim 7, wherein the grounding pin and the connection board are located on two opposite sides of the two metal connection components, respectively.

10. The socket connection assembly according to claim 7, wherein each of the two leading pins and the grounding pin is a flat pin parallel to the first direction.

11. The socket connection assembly according to claim 7, further comprising an electronic device connected between one of the two leading pins and the grounding pin.

12. The socket connection assembly according to claim 7, wherein the socket connection assembly is applied to a power supply device and fixed to a chassis, wherein the chassis comprises a side panel and a fixing component, the socket connection assembly is fixed to the side panel through the fixing component, and the connection board is disposed adjacent to the side plate and inserted into a main board of the power supply device.

13. The socket connection assembly according to claim 12, wherein the fixing component comprises a grounding platform extended from outside to inward, wherein the metal sleeve comprises a second grounding portion spatially corresponding to the grounding platform, and the second grounding portion and the grounding platform are connected to each other.

14. The socket connection assembly according to claim 12, wherein the chassis further comprises a latch disposed on the side plate along the first direction, and parallel to the connection board, wherein the latch is located between the plug-in ends of the two metal connection components and misaligned to the plug-in ends of the two metal connection components in view of the second direction.

15. The socket connection assembly according to claim 12, wherein the socket comprises an engaging protrusion disposed on an outer periphery of the main body, and the fixing component comprises an engaging opening spatially corresponding to the engaging protrusion, wherein the socket is mounted on the fixing component by engaging the engaging protrusion and the engaging opening with each other, and the connection board is disposed adjacent to the side plate.

16. The socket connection assembly according to claim 1, wherein the two leading pins are arranged along a third direction, and are a flat pin, respectively, wherein the third direction is perpendicular to the first direction and the second direction.

17. The socket connection assembly according to claim 1, wherein the two leading pins are both flat pins and each has a wiring hole, wherein after the two leading pins penetrate the fitting ends of the two metal connection components respectively, the wiring holes of the two leading pins remain exposed.
